(19) United States
(12) Patent Application Publication
(10) Pub. No.: US 2008/0137574 A1
(43) Pub. Date: Jun. 12, 2008

(54) Method and apparatus for handling data delivery in a wireless communications system

(75) Inventor: Sam Shiaw-Shiang Jiang, Taipei City (TW)

Correspondence Address: BIRCH STEWART KOLASCH & BIRCH, PO BOX 747, FALLS CHURCH, VA, 22040-0747, US

(73) Assignee: Innovative Sonic Limited

(21) Appl. No.: 12/000,068

(22) Filed: Dec. 7, 2007

Related U.S. Application Data
(60) Provisional application No. 60/869,115, filed on Dec. 8, 2006.

(51) Int. Cl. H04B 7/00; H04L 12/56

(52) U.S. Cl. 370/310; 370/394

(57) ABSTRACT

A method for handling data delivery in a wireless communications system includes receiving a plurality of packets, delivering a first packet with a first sequence number and a second packet with a second sequence number in the plurality of packets to a data processing entity based on a receiving order of the first packet and the second packet, transmitting a relative value indicating a sequential order of the first sequence number and the second sequence number to the data processing entity, and performing a data processing function for the second packet according to the relative value, the first sequence number and the second number by the data processing entity.

### CROSS REFERENCE TO RELATED APPLICATIONS

This application claims the benefit of U.S. Provisional Application No. 60/869,115, filed on Dec. 8, 2006 and entitled “Out-of-sequence delivery for deciphering and header decompression”, the contents of which are incorporated herein by reference.

### BACKGROUND OF THE INVENTION

1. Field of the Invention

The present invention relates to a method and apparatus for handling data delivery in a wireless communications system, and more particularly, to a method and apparatus for accurately performing deciphering and header decompression when out-of-sequence delivery is applied, so as to enhance transmission efficiency and information security.

2. Description of the Prior Art

The third generation mobile telecommunications system (called 3G system) provides high frequency spectrum utilization, universal coverage, and high quality, high-speed multimedia data transmission, and also meets all kinds of QoS requirements simultaneously, providing diverse, flexible, two-way transmission services and better communication quality to reduce transmission interruption rates. However, due to demand for high-speed and multimedia applications, the next generation mobile telecommunications technology and related communication protocols have been developed.

Long Term Evolution wireless communications system (LTE system), an advanced high-speed wireless communications system established upon the 3G mobile telecommunications system, supports only packet-switched transmission, and tends to implement both Medium Access Control (MAC) layer and Radio Link Control (RLC) layer in one single communication site, such as in Node B alone rather than in Node B and RNC (Radio Network Controller) respectively, so that the system structure becomes simple.

Take an LTE-related specification established by the 3GPP for example, the main functions of an RLC (Radio Link Control) layer include in-sequence delivery of upper layer PDUs (Protocol Data Units) except at HO (Handover) in the uplink, and the main functions of a PDCP (Packet Data Convergence Protocol) layer include in-sequence delivery of upper layer PDUs at HO in the uplink. “In-sequence delivery” means that the RLC layer of the receiver delivers received packets to the upper layer in the order of sequence numbers (SNs) of the packets. In other words, the RLC layer should perform reordering to recovery the order of the packets, so as to deliver PDUs in sequence. In such a situation, there may be two possible implementations: (1) the RLC layer performs reordering while the PDCP layer does not; or, (2) Both the PDCP and RLC layers perform reordering.

The requirement of in-sequence delivery in PDCP is induced by the situation that the PDCP layer of the transmitter can use header compression algorithms, such as ROHC (Robust Header Compression), to compress packet headers. In order to accurately decompress packet headers, the PDCP layer of the receiver must ensure that packets arrive a header decompression entity in the order of PDCP SNs. According to a ROHC-related specification, after receiving k bits of a field, the decompressor derives the original value of the field using a previously received value as reference (v_ref). Such scheme is guaranteed to be correct if the compressor and the decompressor each use an interpretation interval: [v_ref−p, v_ref−p+2^{k}−1], where p is an integer used for shifting the interpretation interval. In ROHC, p=1 for k=4 or 6 for RTP (Real Time Protocol) SN field. Thus, an SN jump larger than 2 will generate incorrect decompressed result. Therefore, in-sequence delivery is generally assumed for ROHC. Besides, for k=4 case, if more than consecutive 16 packets get lost during transmission, the decompressed result will be incorrect, leading to packet discard.

For example, please refer to FIG. 1, which illustrates a table of RTP SNs of 31 consecutive packets P1˜P31 and 4-bit ROHC results thereof. As shown in FIG. 1, since k=4, each cycle is formed by 16 compressed values. If context RTP SN=0x0A00 has been established in the decompressor, the decompressor can get correct decompressed SN value as long as the packets P1˜P31 are delivered in sequence. However, suppose that there is out-of-sequence delivery so that the packets arrive in the order of P2, P3, P4, P1, P5, P6, . . . , P31. Then, by ROHC, the decompressed SNs in the order of arrived packets will be 0x0A02, 0x0A03, 0x0A04, 0x0A11, 0x0A15, . . . , 0x0A1F, 0x0A20, 0x0A21, . . . , 0x0A2F. Thus, all the packets except P2, P3 and P4 will be decompressed to have incorrect RTP SNs, which will fail the header CRC (Cyclic Redundancy Check) test and will be discarded finally. Suppose that the packets P4˜P19 get lost over the transmission while all the other packets arrived in sequence, i.e. P1, P2, P3, P20, P21, . . . , P31. Then, by ROHC, the decompressed SNs in the order of arrived packets will be 0x0A01, 0x0A02, 0x0A03, 0x0A04, . . . , 0x0A0F. Thus, the packets P20˜P31 are decompressed with incorrect RTP SNs and will be discarded finally because of header CRC check failure.

Therefore, if the PDCP layer of the transmitter uses ROHC to compress packet headers, the PDCP layer of the receiver must ensure that packets arrive the header decompression entity in the order of PDCP SNs, to correctly decompress the packets and prevent unnecessary packet discard. That is, in-sequence delivery is required. In such a situation, the PDCP layer should check if the packets are delivered in sequence according to their PDCP SNs, leading to extra delay for transmission and waste of system resource.

Except de-/compression operations, PDCP can perform ciphering protection for the packets, in order to protect user data and signaling information from being intercepted by unauthorized devices. Generally, in the prior art ciphering method, the transmitter generates keystream data via a specified algorithm based on ciphering key (CK), ciphering SN, and other parameters or variables, and encrypts plain-text data with the keystream data to generate cipher-text data. The receiver can decipher the cipher-text data by inverse operations. The ciphering SN is composed of a Hyper Frame Number (HFN), maintained in both the transmitter and the receiver, and an SN, embedded in a header of a packet. HFN is similar to a carrying number of SN. Each time SN wraps around its maximum representing value back to 0, HFN is incremented by one in the transmitter and in the receiver. For example, if SN is represented by 7 bits, which counts from 0 to 127, once SN is beyond 127, HFN is incremented by 1, and SN restarts from 0. As a result, according to SN, the sender and the receiver can timely increment HFN, so as to keep synchronization of HFN and maintain ciphering and deciphering processes.

Since HFN is similar to a carrying number of SN, if packets do not arrive the receiver in the order of their SNs, HFN may be wrongly accumulated leading to HFN out of synchronization, causing deciphering failure. In other words, before performing deciphering, the PDCP layer must ensure that the order of packets is the same as the order of generating the packets. However, the prior art does not specify the sequence of performing deciphering and performing reordering, so that deciphering may be performed before reordering. In addition, reordering increases the requirement of buffer memory for a mobile and increases reordering processing time so that transmitting throughput is degraded. In such a situation, if out-of-sequence delivery is applied by the lower layer, HFN may be wrongly accumulated leading to HFN out of synchronization, causing deciphering failure.

### SUMMARY OF THE INVENTION

According to the present invention, a method for handling data delivery in a wireless communications system comprises receiving a plurality of packets, delivering a first packet with a first sequence number and a second packet with a second sequence number in the plurality of packets to a data processing entity based on a receiving order of the first packet and the second packet, transmitting a relative value indicating a sequential order of the first sequence number and the second sequence number to the data processing entity, and performing a data processing function for the second packet according to the relative value, the first sequence number and the second number by the data processing entity.

According to the present invention, a communications device for accurately performing data delivery in a wireless communications system comprises a control circuit for realizing functions of the communications device, a processor installed in the control circuit, for executing a program code to command the control circuit, and a memory installed in the control circuit and coupled to the processor for storing the program code. The program code comprises receiving a plurality of packets, means of delivering a first packet with a first sequence number and a second packet with a second sequence number in the plurality of packets to a data processing entity based on a receiving order of the first packet and the second packet, transmitting a relative value indicating a sequential order of the first sequence number and the second sequence number to the data processing entity, and performing a data processing function for the second packet according to the relative value, the first sequence number and the second number by the data processing entity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1, illustrates a table of RTP SNs of 31 consecutive packets P1˜P31 and 4-bit ROHC results thereof.

FIG. 2 is a function block diagram of a wireless communications device.

FIG. 3 is a diagram of program code of FIG. 2.

FIG. 4 is a flowchart of a process according to an embodiment of the present invention.

### DETAILED DESCRIPTION

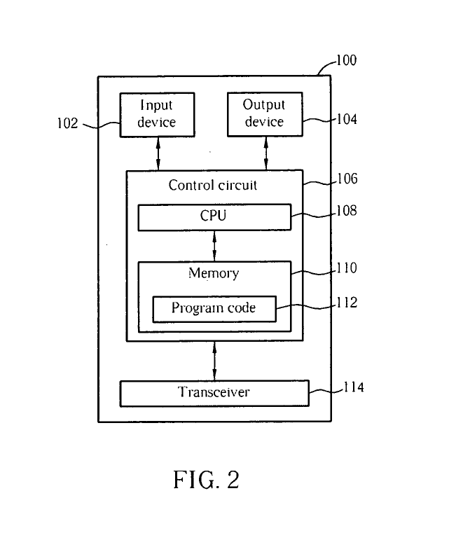

Please refer to FIG. 2, which is a functional block diagram of a communications device 100 in a wireless communications system. The wireless communications system is preferably the LTE system. For the sake of brevity, FIG. 2 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3.

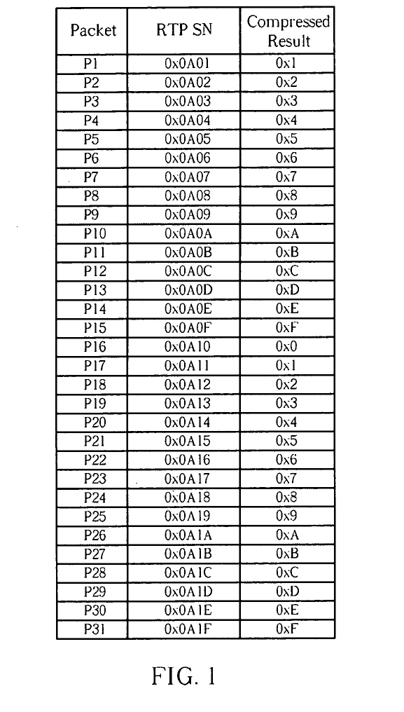

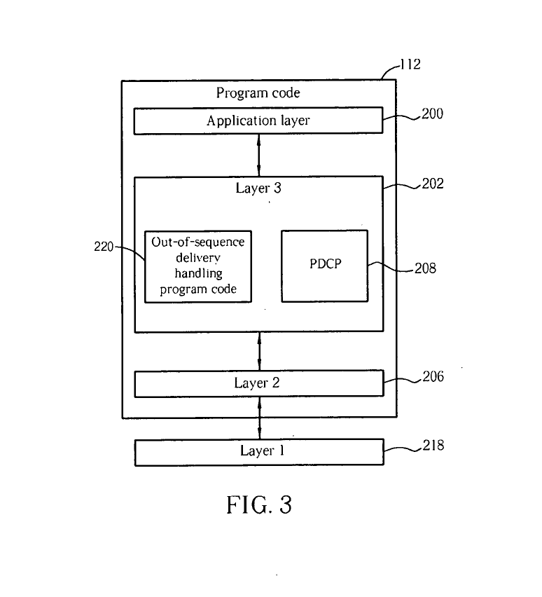

Please continue to refer to FIG. 3. FIG. 3 is a diagram of the program code 112 shown in FIG. 2. The program code 112 includes an application layer 200, a Layer 3 202, and a Layer 2 206, and is coupled to a Layer 1 218. The Layer 3 202 comprises a PDCP layer 208. The Layer 2 206 comprises an RLC layer and a MAC layer, and performs link control. The Layer 1 218 performs physical connections. Note that, although the PDCP layer 208 is contained in the block of Layer 3 202 in FIG. 1, it could also be seen as contained in the block of Layer 2 206. Whether the PDCP layer 208 is considered to belong to Layer 2 or Layer 3 is not relevant to this invention.

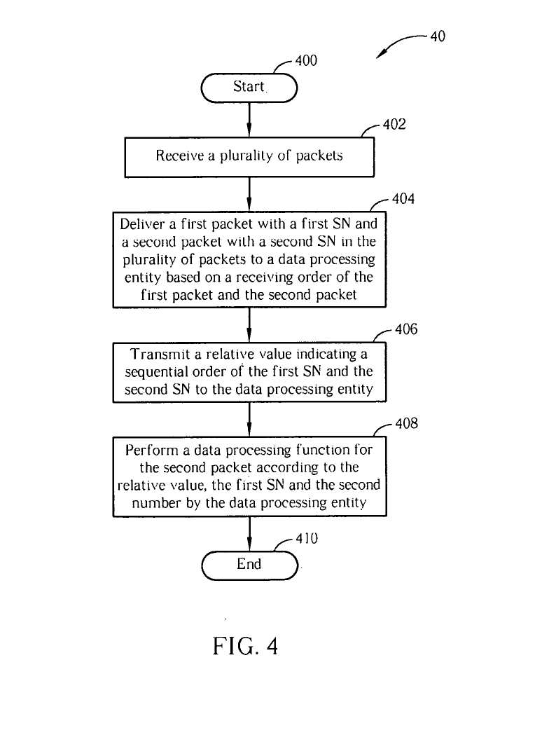

In order to enhance transmission efficiency and information security, the PDCP layer 208 can perform header decompressing, as specified by the ROHC specification, and deciphering for packets. In such a situation, the embodiment of the present invention provides an out-of-sequence delivery handling program code 220, to accurately handling SNs of packets delivered out of sequence, so as to prevent decompression and deciphering failures. Please refer to FIG. 4, which illustrates a process 40 according to an embodiment of the present invention. The process 40 is used for handling out-of-sequence delivery in a PDCP layer of a wireless communications system, and can be compiled into the out-of-sequence delivery handling program code 220. The process 40 comprises the following steps:
Step 400: Start.
Step 402: Receive a plurality of packets.
Step 404: Deliver a first packet with a first SN and a second packet with a second SN in the plurality of packets to a data processing entity based on a receiving order of the first packet and the second packet.
Step 406: Transmit a relative value indicating a sequential order of the first SN and the second SN to the data processing entity.
Step 408: Perform a data processing function for the second packet according to the relative value, the first SN and the second number by the data processing entity.
Step 410: End.

According to the process 40, the embodiment of the present invention delivers packets to the data processing entity in the order of receiving the packets rather than the order of SNs of the packets. That is, out-of-sequence delivery is applied in the embodiment of the present invention. During packet delivery, the embodiment of the present invention transmits relative values to the data processing entity, to indicate the sequential order of SNs, and the data processing entity can perform a specified data processing function for the received packets accordingly. In other words, the embodiment of the present invention supports out-of-sequence delivery, and to prevent problems caused by out-of-sequence delivery, the embodiment of the present invention further transmits the relative values indicating the sequential order of SNs to the data processing entity, so as to accurately perform the data processing function.

In the process 40, preferably, the relative value further indicates a distance between the first SN and the second SN. The embodiment of the present invention can transmits the relative value to the data processing entity along with delivering the second packet to the data processing entity, or when the second SN is before the first SN, or when the distance between the first SN and the second SN is greater than a predefined value (e.g. 1).

Moreover, preferably, the data processing function can be a deciphering function or a header decompression function. If the data processing function is the deciphering function, then in Step 408, the data processing entity can adjust a deciphering parameter (e.g. HFN) corresponding to the second packet according to the relative value, the first SN, the second SN, and a deciphering parameter (e.g. HFN) corresponding to the first packet, so as to decipher the second packet. In other words, the data processing entity can determine the exact order of SNs according to the relative values, and adjust deciphering parameters correspondingly, so as to accurately perform deciphering. As mentioned above, HFN is maintained in both the transmitter and the receiver. HFN is similar to a carrying number of SN. Each time SN wraps around its maximum representing value back to 0, HFN is incremented by one in the transmitter and in the receiver. Therefore, when the data processing function is the deciphering function, Step 408 preferably comprises four operations for adjusting HFN as follows:

1. The second SN is greater than the first SN, and the relative value indicates the second SN is before the first SN: representing that the second SN is the former SN cycle comparing to the first SN. Therefore, when deciphering the second packet, the data processing entity sets a result of subtracting 1 from HFN corresponding to the first packet as HFN corresponding to the second packet.

2. The second SN is smaller than the first SN, and the relative value indicates the second SN is after the first SN: representing that the second SN is the next SN cycle comparing to the first SN. Therefore, when deciphering the second packet, the data processing entity sets a result of adding 1 to HFN corresponding to the first packet as HFN corresponding to the second packet.

3. The second SN is greater than the first SN, and the relative value indicates the second SN is after the first SN: representing the SN cycle of the second SN is the same as that of the first SN. Therefore, when deciphering the second packet, the data processing entity sets HFN corresponding to the first packet as HFN corresponding to the second packet.

4. The second SN is smaller than the first SN, and the relative value indicates the second SN is before the first SN: representing the SN cycle of the second SN is the same as that of the first SN. Therefore, when deciphering the second packet, the data processing entity sets HFN corresponding to the first packet as HFN corresponding to the second packet.

Therefore, via the above operations, the data processing entity can adjust HFN corresponding to the second packets, so as to accurately decipher the second packet and prevent deciphering failure.

In addition, when the data processing function is the header decompression function, then in Step 408, the data processing entity can preferably adjust an interpretation interval corresponding to the second packet according to the relative value, the first SN, the second SN, and the decompressed result of the first packet, so as to decompress the header of the second packet. In other words, the data processing entity can determine the exact order of SNs, and adjust the interpretation interval accordingly, so as to accurately perform decompression.

Take FIG. 1 for example, suppose that context RTP SN=0x0A00 has been established in the decompressor, and there is out-of-sequence delivery so that the packets arrive in the order of P2, P3, P4, P1, P5, P6, . . . , P31. Since the packet P1 does not arrive in sequence, the embodiment of the present invention transmits a relative value, 1−4=−3, along with delivering the packet P1 to indicate that the packet P1 leads the packet P4 by 3 SN. As a result, when decompressing the header of the packet P1, the decompressor can shift the interpretation interval corresponding to the packet P1 from [0x0A03, 0x0A12] by −3 to [0x0A00, 0x0A0F], so that decompressed RTP SN of the packet P1 will be 0x0A01, which is correct. Meanwhile, the decompressed RTP SN of the rest packets will be 0x0A05, . . . , 0x0A0F, 0x0A10, 0x0A11, . . . , 0x0A1F. Thus, all the packets can be decompressed correctly.

In addition, suppose that the packets P4˜P19 get lost over the transmission while all the others arrived in sequence, i.e. P1, P2, P3, P20, P21, . . . , P31. Since the packets P4˜P19 get lost, the embodiment of the present invention can transmits a relative value, 20−3=17, along with delivering the packet P20 to indicate that the packet P20 is after the packet P3 by 17 SN. As a result, when decompressing the header of the packet P20, the decompressor can shift the interpretation interval corresponding to the packet P20 from [0x0A02, 0x0A11] to [0x0A13, 0x0A22], so that the decompressed RTP SN of P20 will be 0x0A14, and the decompressed SN in the order of the rest packets will be 0x0A15, 0x0A16, . . . , 0x0A1F, which are correct.

In summary, when out-of-sequence delivery is applied, the embodiment of the present invention can transmit relative values to the next data processing entity according to the order of SNs, so that the data processing entity can determine the order of SNs and adjust deciphering parameters or interpretation intervals, so as to accurately perform deciphering or header decompression, to enhance transmission efficiency and information security.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for handling data delivery in a wireless communications system comprising:
receiving a plurality of packets;
delivering a first packet with a first sequence number and a second packet with a second sequence number in the plurality of packets to a data processing entity based on a receiving order of the first packet and the second packet;
transmitting a relative value indicating a sequential order of the first sequence number and the second sequence number to the data processing entity; and
performing a data processing function for the second packet according to the relative value, the first sequence number and the second number by the data processing entity.

2. The method of claim 1, wherein transmitting the relative value to the data processing entity is transmitting the relative value to the data processing entity along with delivering the second packet to the data processing entity.

3. The method of claim 1, wherein transmitting the relative value to the data processing entity is transmitting the relative value to the data processing entity when the second sequence number is before the first sequence number.

4. The method of claim 1, wherein the relative value further indicates a distance between the first sequence number and the second sequence number.

5. The method of claim 4, wherein transmitting the relative value to the data processing entity is transmitting the relative value to the data processing entity when the distance between the first sequence number and the second sequence number is greater than a predefined value.

6. The method of claim 1, wherein the data processing function is a deciphering function.

7. The method of claim 6, wherein performing the data processing function for the second packet according to the relative value, the first sequence number and the second number by the data processing entity is adjusting a deciphering parameter corresponding to the second packet according to the relative value, the first sequence number, the second number and a deciphering parameter corresponding to the first packet by the data processing entity, so as to perform the deciphering function.

8. The method of claim 7, wherein the deciphering parameter corresponding to the second packet is a Hyper Frame Number.

9. The method of claim 7, wherein adjusting the deciphering parameter corresponding to the second packet according to the relative value, the first sequence number, the second number and the deciphering parameter corresponding to the first packet by the data processing entity is setting a result of subtracting 1 from the deciphering parameter corresponding to the first packet as the deciphering parameter corresponding to the second packet by the data processing entity when the second sequence number is greater than the first sequence number and the relative value indicates that the second sequence number is before the first sequence number.

10. The method of claim 7, wherein adjusting the deciphering parameter corresponding to the second packet according to the relative value, the first sequence number, the second number and the deciphering parameter corresponding to the first packet by the data processing entity is setting a result of adding 1 to the deciphering parameter corresponding to the first packet as the deciphering parameter corresponding to the second packet by the data processing entity when the second sequence number is smaller than the first sequence number and the relative value indicates that the second sequence number is after the first sequence number.

11. The method of claim 7, wherein adjusting the deciphering parameter corresponding to the second packet according to the relative value, the first sequence number, the second number and the deciphering parameter corresponding to the first packet by the data processing entity is setting the deciphering parameter corresponding to the first packet as the deciphering parameter corresponding to the second packet by the data processing entity when the second sequence number is greater than the first sequence number and the relative value indicates that the second sequence number is after the first sequence number.

12. The method of claim 7, wherein adjusting the deciphering parameter corresponding to the second packet according to the relative value, the first sequence number, the second number and the deciphering parameter corresponding to the first packet by the data processing entity is setting the deciphering parameter corresponding to the first packet as the deciphering parameter corresponding to the second packet by the data processing entity when the second sequence number is smaller than the first sequence number and the relative value indicates that the second sequence number is before the first sequence number.

13. The method of claim 1, wherein the data processing function is a header decompression function.

14. The method of claim 13, wherein performing the data processing function for the second packet according to the relative value, the first sequence number and the second number by the data processing entity is adjusting an interpretation interval corresponding to the second packet according to the relative value, the first sequence number, the second number and a decompression result corresponding to the first packet by the data processing entity, so as to perform the decompression function.

15. A communications device for accurately performing data delivery in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
receiving a plurality of packets;
receiving a plurality of packets;
delivering a first packet with a first sequence number and a second packet with a second sequence number in the plurality of packets to a data processing entity based on a receiving order of the first packet and the second packet;
transmitting a relative value indicating a sequential order of the first sequence number and the second sequence number to the data processing entity; and
performing a data processing function for the second packet according to the relative value, the first sequence number and the second number by the data processing entity.

16. The communications device of claim 15, wherein transmitting the relative value to the data processing entity is transmitting the relative value to the data processing entity along with delivering the second packet to the data processing entity.

17. The communications device of claim 15, wherein transmitting the relative value to the data processing entity is transmitting the relative value to the data processing entity when the second sequence number is before the first sequence number.

18. The communications device of claim 15, wherein the relative value further indicates a distance between the first sequence number and the second sequence number.

19. The communications device of claim 18, wherein transmitting the relative value to the data processing entity is transmitting the relative value to the data processing entity when the distance between the first sequence number and the second sequence number is greater than a predefined value.

20. The communications device of claim 15, wherein the data processing function is a deciphering function.

21. The communications device of claim 20, wherein performing the data processing function for the second packet according to the relative value, the first sequence number and the second number by the data processing entity is adjusting a deciphering parameter corresponding to the second packet according to the relative value, the first sequence number, the second number and a deciphering parameter corresponding to the first packet by the data processing entity, so as to perform the deciphering function.

22. The communications device of claim 21, wherein the deciphering parameter corresponding to the second packet is a Hyper Frame Number.

23. The communications device of claim 21, wherein adjusting the deciphering parameter corresponding to the second packet according to the relative value, the first sequence number, the second number and the deciphering parameter corresponding to the first packet by the data processing entity is setting a result of subtracting 1 from the deciphering parameter corresponding to the first packet as the deciphering parameter corresponding to the second packet by the data processing entity when the second sequence number is greater than the first sequence number and the relative value indicates that the second sequence number is before the first sequence number.

24. The communications device of claim 21, wherein adjusting the deciphering parameter corresponding to the second packet according to the relative value, the first sequence number, the second number and the deciphering parameter corresponding to the first packet by the data processing entity is setting a result of adding 1 to the deciphering parameter corresponding to the first packet as the deciphering parameter corresponding to the second packet by the data processing entity when the second sequence number is smaller than the first sequence number and the relative value indicates that the second sequence number is after the first sequence number.

25. The communications device of claim 21, wherein adjusting the deciphering parameter corresponding to the second packet according to the relative value, the first sequence number, the second number and the deciphering parameter corresponding to the first packet by the data processing entity is setting the deciphering parameter corresponding to the first packet as the deciphering parameter corresponding to the second packet by the data processing entity when the second sequence number is greater than the first sequence number and the relative value indicates that the second sequence number is after the first sequence number.

26. The communications device of claim 21, wherein adjusting the deciphering parameter corresponding to the second packet according to the relative value, the first sequence number, the second number and the deciphering parameter corresponding to the first packet by the data processing entity is setting the deciphering parameter corresponding to the first packet as the deciphering parameter corresponding to the second packet by the data processing entity when the second sequence number is smaller than the first sequence number and the relative value indicates that the second sequence number is before the first sequence number.

27. The communications device of claim 15, wherein the data processing function is a header decompression function.

28. The communications device of claim 27, wherein performing the data processing function for the second packet according to the relative value, the first sequence number and the second number by the data processing entity is adjusting an interpretation interval corresponding to the second packet according to the relative value, the first sequence number, the second number and a decompression result corresponding to the first packet by the data processing entity, so as to perform the decompression function.
